(19) United States
(12) Patent Application Publication
(10) Pub. No.: US 2019/0141075 A1
(43) Pub. Date: May 9, 2019

(54) METHOD AND SYSTEM FOR A PROTECTION MECHANISM TO IMPROVE SERVER SECURITY

(71) Applicant: Monarx, Inc., Salt Lake City, UT (US)

(72) Inventors: Jonathan William Gay, Salt Lake City, UT (US); Thomas Christian Gay, Salt Lake City, UT (US); John Olaf Kunkel, San Diego, CA (US); Scott David Swanson, Salt Lake City, UT (US)

(21) Appl. No.: 15/808,721

(22) Filed: Nov. 9, 2017

(51) Int. Cl. H04L 29/06; H04L 29/08

(52) U.S. Cl. CPC H04L 63/1441; H04L 67/02; H04L 63/1416; H04L 63/101

(57) ABSTRACT

A method and system for a protection mechanism associated with a server to prevent execution of malicious code. The method includes identifying permissions of a set of files by the protection mechanism where the set of files are related to a request sent to the server, determining whether the request references any file in the set of files with inappropriate permissions, and blocking the request from being executed by a processing engine in response to determining the request is associated with at least one file with improper permissions.

### TECHNICAL FIELD

Embodiments of the invention relate to the field of server security; and more specifically, to an apparatus and method for improving server security using a protection mechanism to prevent execution of malicious code by a processing engine.

### BACKGROUND

Protecting servers from attack of malicious code has been an ongoing focus to improve the security of the servers and protect the operation of the server as well as the data managed by the server. Existing approaches to protecting servers from malicious code (e.g., malicious scripts) fall into the categories of Anti-virus software and signature scanning software that identify suspicious or malicious code. These approaches search for forms of obfuscation that hide malicious code such as code hidden in various types of script files. One type of malicious code that is searched for using these sorts of techniques is webshells, which are scripts that are uploaded to a server and may enable remote administration of the webserver.

The existing server protection techniques can be used to detect and remediate webshells. These techniques are scanning solutions that look for the existence of webshells on the servers file system based off of known signatures. They identify webshells using traditional signature matching (e.g., using a hash or simple string), entropy to detect obfuscation, more complex string searching or a combination of these techniques. However, these existing techniques do not stop webshells from being executed once they are present on a system. These techniques will only alert an administrator that a webshell exists and some will delete the file that includes the webshell if the file includes a known signature associated with a webshell. Thus, these existing techniques may not close the exploits or methods used to insert the webshell onto the server in the first place, thereby leaving the server open to further intrusion. These techniques also do not stop the webshell from being executed if it is successfully loaded onto the server and this enables a webshell to be utilized in order to do harm.

The existing techniques primarily identify the webshells so that administrators can remove them and fix any damage they may have caused. Some existing techniques, such as Anti-Virus software will delete webshells or the files including the webshells albeit with low detection rates for finding the webshells and their associated files. The difficulty in identifying and stopping webshells lies in the many ways these files can be modified, manipulated or obfuscated. These webshells can also be spread across multiple files. Many servers allow legitimate files to be uploaded, but detecting malicious code in files is difficult and is reactive to detecting new methods of obfuscation and modification of the malicious code.

Some approaches also try and block the upload of webshell related files using Web Application Firewalls. A Web Application Firewall (WAF) is a special type of application firewall that applies specifically to web applications. It is deployed in front of web applications and analyzes bi-directional web-based (HTTP) traffic—detecting and blocking anything known to be malicious. WAFs generally use signatures to block known intrusion pathways that would result in servers becoming compromised with webshells. However, the use of WAFs is no more successful than the other techniques. By their nature, webshells (and similar malicious scripts) are easy to change, WAFs are not effective in blocking the introduction of webshells, but attempt to prevent the original attack vectors that allows for a webshell to be inserted in the first place. All of these existing techniques are forms of perimeter/network defense systems that do not block the webshell from being accessed once a file with a webshell is present on a server, and they do not stop the webshell from executing its functions once they are on the server.

### SUMMARY

In one embodiment, a method for a protection mechanism associated with a server to prevent execution of malicious code is provided. The method includes identifying permissions of a set of files by the protection mechanism where the set of files are related to a request sent to the server, determining whether the request references any file in the set of files with inappropriate permissions, and blocking the request from being executed by a processing engine in response to determining the request is associated with at least one file with improper permissions.

In another embodiment, an apparatus is provided to execute the method for the protection mechanism associated with the server, which prevents execution of malicious code. The apparatus includes a non-transitory computer readable medium having stored therein a protection mechanism and a processing engine and a processor communicatively coupled to the non-transitory computer readable medium. The processor is configured to execute the processing engine and the protection mechanism. The protection mechanism is configured to identify permissions of a set of files by the protection mechanism where the set of files are related to a request sent to the server, to determine whether the request references any file in the set of files with inappropriate permissions, and to block the request from being executed by the processing engine in response to determining the request is associated with at least one file with improper permissions.

In a further embodiment, a non-transitory computer-readable medium is provided that has stored therein a set of instructions, which when executed by a computing device cause the computing device to perform a set of operations to implement the protection mechanism associated with the server to prevent execution of malicious code. The set of operations includes identifying permissions of a set of files by the protection mechanism where the set of files are related to a request sent to the server, determining whether the request references any file in the set of files with inappropriate permissions, and blocking the request from being executed by a processing engine in response to determining the request is associated with at least one file with improper permissions.

### BRIEF DESCRIPTION OF THE DRAWINGS

The invention may best be understood by referring to the following description and accompanying drawings that are used to illustrate embodiments of the invention. In the drawings:

FIG. 1 is a diagram of one embodiment of a process for installing an agent at a target device.

FIG. 2 is a flowchart of another embodiment of a process to install an agent on a web server.

FIG. 3 is a flowchart of one embodiment of a process for handling requests at a server.

FIG. 4 is a flowchart of another embodiment of a process for handling hyper-text transfer protocol requests at a web server.

FIG. 5 is a diagram of one embodiment of a network architecture for the operation of a protection mechanism and security service.

FIG. 6 is a diagram of one embodiment of a computing device implementing a protection mechanism.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The operations depicted in the flow diagrams in the attached figures will be described with reference to the exemplary embodiments shown in the attached figures. However, it should be understood that the operations depicted in the flow diagrams can be performed by embodiments of the invention other than those discussed with reference to the attached figures, and the embodiments discussed with reference to the diagrams in the attached figures can perform operations different than those discussed with reference to the flow diagrams of the attached figures.

The techniques shown in the figures can be implemented using code and data stored and executed on one or more electronic devices (e.g., an end station, a network element, etc.). Such electronic devices store and communicate (internally and/or with other electronic devices over a network) code and data using non-transitory machine-readable or computer-readable media, such as non-transitory machine-readable or computer-readable storage media (e.g., magnetic disks; optical disks; random access memory; read only memory; flash memory devices; and phase-change memory) and transitory computer -readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices, user input/output devices (e.g., a keyboard, a touch screen, and/or a display), and network connections. A ‘set,’ as used herein, refers to any positive whole number of items. The coupling of the set of processors and other components is typically through one or more busses and bridges (also termed as bus controllers). The storage devices represent one or more non-transitory machine-readable or computer-readable storage media and non-transitory machine-readable or computer-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

Overview

There are few different ways to address the problem of malicious code being executed at a server. These techniques include patching, code and website scanning, web application firewalls (WAFs), runtime application self-protection security (RASPs), open source webshell scanning tools and anti-virus software. Each of these techniques has limitations and inefficiencies that are addressed by the embodiments. Patching is a technique that keeps web applications patched to the latest version. This technique is premised on one of the most effective ways to protect against attacks being to ensure that every machine in the environment has the latest patches installed. Patching makes it much harder to exploit a server. If a vulnerability cannot be exploited then it removes the attack vectors used to introduce a webshell to the system. However, patching is reactive and requires the identification of new vectors of attack and a method to address the attack.

Code and website scanning is a technique that is commonly employed in the security industry. By running automated scanning tools known as Static Application Security Testing (SAST) and Dynamic Application Security (DAST) an administrator can identify security flaws in the web application code. These flaws can be used to introduce webshells to a system. Tools and services available that utilize this technique can be time and resource consuming and it can be difficult to handle the frequency of website code changes.

Web application firewalls (WAFs) are deployed in front of web servers to protect web applications against external and internal attacks, to monitor and control access to web applications, and to collect access logs for compliance/auditing and analytics. WAF are effective for common types attacks, large scale attacks and can implement virtual patching. WAFs require a consistent effort in terms of configuration to be effective, have high false positive rates and detection is based on basic pattern matching. Even with a WAF deployed to protect a server, webshells can still be introduced to the server as they are often used for only detection and are focused on a limited range of types of attacks.

Runtime application self-protection security (RASP) is a security technology that is built or linked into an application or application runtime environment, and is capable of controlling application execution and detecting and preventing real-time attacks. It is primarily used to block exploitation. They are limited in the types and varieties of attacks that they can prevent. Even with a RASP in place it does not protect against the introduction of webshells given vulnerabilities can exist outside of what the RASP can see.

Open source webshell scanning tools are really webshell scanning applications that are community supported. They take a few different approaches to find webshells using hash based signatures, YARA rules, looking for obfuscation or rules looking for presence of specific functions within the script. They are only used for non-real-time detection and do not prevent the introduction and execution of webshells. They typically have high false positive rates, are not actively supported, and detection rates are below 90%.

Anti-Virus software treats webshells as a form of malware. Some anti-virus software claims to provide a solution to webshells, but the reality is they have a very low efficacy and detection rates for webshells in some studies less than 40%. Anti-virus software employs various types of scanning techniques and have difficulty in keeping up with the fast-changing nature of webshells. Webshells can be easily modified. Making traditional hash based and known file scanning approaches is not very effective in detecting and removing webshells from a server.

The embodiments provide a cloud delivered security software that secures servers (e.g., webservers) against malware attacks. The embodiments encompass variations that scan servers for the existence of malicious script files (webshells) with a high level of accuracy, that scan the server to determine and track security posture (attack surface), and that prevent the execution of any malicious scripts (webshells). In particular the embodiments introduce a protection mechanism for webshell prevention and mitigation. The protection mechanism prevents execution of any webshell files that have been inserted onto a webserver either manually or via automated methods. The protection mechanism can be a server-side scripting language extension or similar code that works in conjunction with any server software (e.g., any type of webserver software). The protection mechanism can detect and prevent all webshells from being executed making them inert once they are on a server or association computing system. The embodiments do not require webshell type determination to prevent the web shell from being executed and doing harm. The embodiments also provide visibility into the Internet Protocol (IP) address of the attacker's system and the exact server-side script file used to compromise the system. This information can be collected and used for further analysis and in conjunction with other protection techniques.

The embodiments introduce a protection mechanism that can be a code extension for a server-side processing engine or similarly implemented. The protection mechanism will work inside interpreted, bytecode compiled, or machine code compiled languages for server-side scripting languages. The protection mechanism functions as described further herein below and can be installed at a server via an agent. The protection mechanism and/or agent can also function in conjunction with a security service. The security service can be provided by a system (e.g., a cloud implementation) that is remote from the server in which the protection mechanism and agent operate. After a protection mechanism is installed in a server-side processing engine, referred to herein primarily as the processing engine (e.g., a hypertext preprocessor (PHP) engine or any other server-side scripting language), the agent identifies the installed server-side scripting languages. The agent then re-permissions a subset of files at the server into new permission groups. This re-permissioning isolates aspects of the server software (e.g., the webserver user group).

Each time the processing engine loads a file (e.g., a server-side script file) the protection mechanism then interrupts the call (or similarly intercedes) within the processing engine and examines the permission of the files that are to be accessed. Any files (e.g., files containing scripts) introduced to the server after the protection mechanism has been enabled (i.e., after the file re-permissioning has taken place) will not meet the permissions criteria enforced by the protection mechanism that is required by the protection mechanism to allow a script to run. The protection mechanism may intercept the file (e.g., script) loading process, evaluate the permissions of files identified in the script and will block execution if the files do not meet the appropriate permission criteria. From the perspective of the malicious actor, the operation of the protection mechanism will be unknown and in one embodiment, the server will return an ambiguous response to a submitted request of the malicious user (e.g., a blank page or screen is sent as a reply to a hypertext transfer protocol (HTTP) request sent by the malicious user). This process of the protection mechanism provides an absolute prevention mechanism to stop malicious code such as webshells without requiring prior knowledge of the type or signature of malicious scripts.

The embodiments provide various advantages over the existing technologies. The embodiments do not require a process to detect and block malicious files from entering the system being protected. Detecting and preventing the malicious files from infecting a server (e.g., a web server) has traditionally been very difficult. Any vulnerability in custom and application software being used by the web server can be leveraged to compromise the web server and inject web shells. Vulnerabilities exist in almost all web server software packages and will often stay open in a server system for years depending on vendor and organizational practices. Closing these vulnerabilities requires the administrators of the server system to continuously patch and update the server systems, and creates huge amounts of work and effort. Zero-day vulnerabilities are often exposed and, until patches are issued, and until teams execute the patch, the known vulnerability will be open for exploitation, allowing insertion of these web shells. The embodiments provide a process and mechanism that does not try to block these files from being inserted on the system using traditional detection methods, the embodiments prevent the untrusted files from being executed. This enables users of the embodiments to not have to constantly try and detect the presence of web shells or worry about the negative outcomes of a webshell compromise. Also, it eliminates the need for security and operations teams to dig through servers logs to try and identify changes and unauthorized activity because of a webshell compromise.

Agent Operation and Protection Mechanism Installation

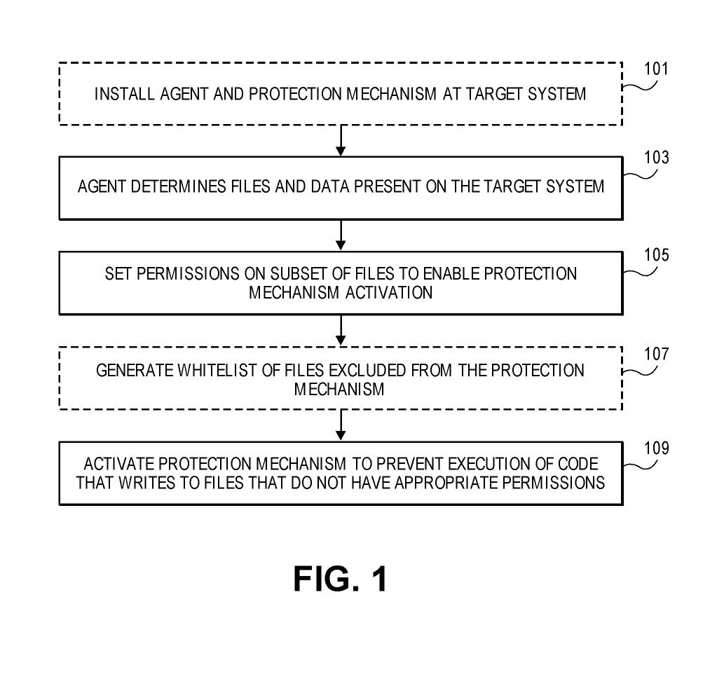

FIG. 1 is a diagram of one embodiment of a process for installing an agent at a target device. The example of FIG. 1 is applicable to the operation of a protection mechanism and agent on any type of server software and server operating environment. The process is initiated by an administrator or similar user that causes the agent to be loaded or installed at the server operating on a target system (Block 101). As part of the agents' installation or after the agent's installation, the protection mechanism is installed at the server. In other embodiments, the protection mechanism may be separately and independently installed in the server, rather than by the agent. The server can be any type of server software that is operating on a physical server or in a virtualized environment. The server software is software that provides any type of service to a user that sends requests for the offered services to the server. The agent may be installed as part of the server components or as a separate software component. The server software operates in conjunction with or with a component that functions as a processing engine. The processing engine is software that functions to service some aspect of the requests received by the server. In particular, the processing engine in the embodiments handles the execution of any code and accesses (i.e., reads or writes) to files of the server or that are related to the server in the server operating environment. In some embodiments, the processing engine is a parser or scripting engine. The protection mechanism may be installed to specifically function in conjunction with the processing engine. In some embodiments, the server may have multiple processing engines that execute different types of codes or service different types of requests. The protection mechanism may be installed to interface or intercede in the operation of any of these processing engines. The protection mechanism may have separate instances or installations per processing engine.

The agent may perform a search or scan of the files in the execution environment of the server (Block 103). The agent may catalog or similarly identify each of the files or similar data structures in the execution environment of the server. This can include identifying files that are part of the server software as well as any other files that may be present or accessible in file systems that are attached to execution environment of the server. The files can be crawled or similarly scanned on attached physical media or in virtual volumes accessible to the server. With each of the files identified the agent may report this information to a security service. The security service can be implemented in a cloud platform or similar remote location and can perform any type of analysis on the provided scan results. In some embodiments, the scan may include an identification of files that may be malicious or contain malicious code. Such malicious files can be deleted, quarantined, reported or similarly handled.

After completion of the scan to determine the local files, permissions may be set or altered on a subset of the identified files (Block 105). This re-permissioning of the subset of identified files enables activation or proper operation of the protection mechanism. In some embodiments, the files are re-permissioned such that there is a clear delineation between the files that constitute the server software and that are managed (i.e., writeable) by the server software. In some embodiments, the re-permissioning ensures that a distinct user is associated with these identified subset of files. This enables the protection mechanism to identify files that the server software should or should not be modifying and thereby to identify files with malicious code. In this manner the protection mechanism can be activated to intercede to examine the permissions of files that are accessed by the processing engine and to block the execution of code that involves files without the appropriate permission scheme (Block 109). The permission scheme can have a range of possible implementations where the owner or associated permission characteristics are identifiable to the protection mechanism and thereby enable identification of files associated with malicious code such as webshells.

In one embodiment, a whitelist may be generated locally by the agent (Block 107). The whitelist identifies a separate subset of the identified files that are permitted to be executed or accessed by a processing engine. The administrator or similar user can identify files by adding them to the whitelist or the agent may automatically identify these files. Any combination of automatic or administered generation of the whitelist may be implemented. In some embodiments, the whitelist is provided partially or wholly by the security service. In such embodiments, the security service may analyze the files that are local to the server with the protection mechanism and send the agent a whitelist to install or a list of files to add to such a whitelist. In some embodiments, rather than a separate discrete list, the agent may alter file permissions to enable operation of the protection mechanism to effectively permit execution or access to specific files.

Example Agent and Protection Mechanism Activation

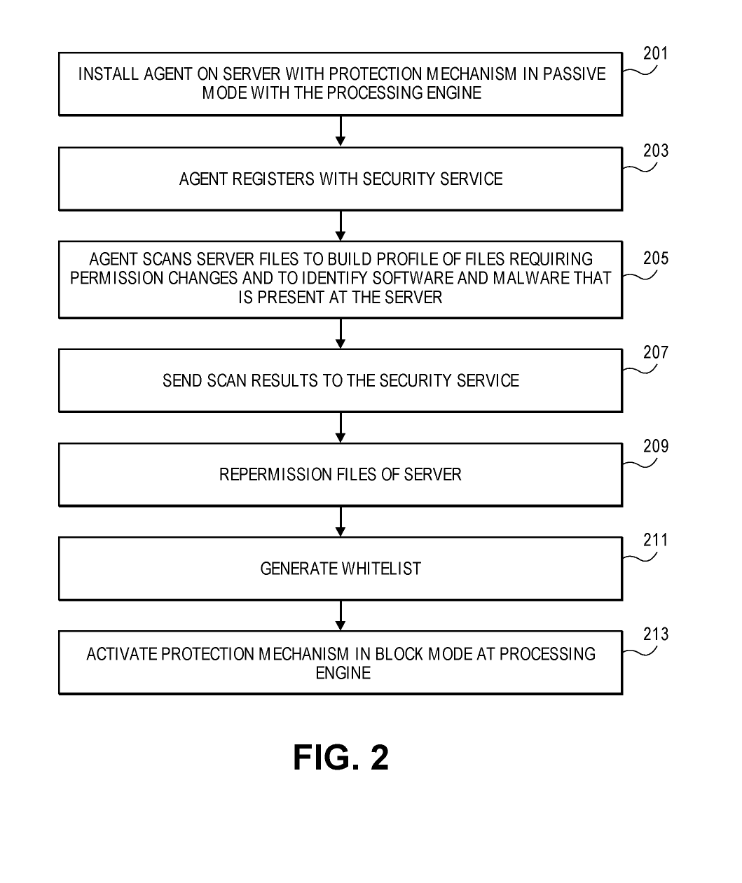

FIG. 2 is a flowchart of another embodiment of a process to install an agent on a web server. This example embodiment provides a context of utilizing the protection mechanism in a web server that includes a PHP engine (i.e., as a processing engine). In this embodiment, an agent may be installed at the web server along with a protection mechanism that is installed as an extension to the PHP engine (Block 201). The protection mechanism may be installed in a ‘passive’ mode where it does not yet operate to intercede in the operation of the PHP engine.

The agent may register with the security service using any communication protocol (Block 203). The security service may provide a communication application programming interface (API) to enable the agent to interface with the functions and services of the security service. When registering with the security service the agent may exchange some configuration information or receive operating information from the security service. The agent may then scan the files of the server to build a profile of the files of the server and to identify the files that require a re-permissioning (Block 205). In some embodiments, the agent may confirm and catalog the location of all files that are controlled by the web server. The agent may also identify if there are any script files that have been uploaded in to the media folders and locate any webshells and delete them. In addition, the agent may locate any other script files that may have already been compromised or that may include injected code, which may be obfuscated. Scanning for already existing malicious code is optional and separate from the operations that directly affect the implementation of the protection mechanism. When the agent identifies local files, it may seek to isolate the webserver files (e.g., files to which an Apache/NGINX webserver have access) or more specifically the user/group permission set of the web server. The agent can provide the results of the file scan to the security service (Block 207). The security service can log or analyze the results of the scan.

The agent may then re-permission the files of the server (Block 209). The re-permissioning of files can set the permissions and ownership of the files such that the web server user is different than that of other files in the system. The agent may also modify the webserver configuration so that each webserver is running as a unique user per instance of the webserver. The agent may further manipulate permissions on all files to separate them from a group of files that is writeable by the web server. This reduces permissions for some files. In some embodiments, the agent may manipulate the media and image folders and files to be writeable by the web server, which adds bare minimum permissions back to these files. As a result, a specific subset of files will have write access by the webserver user/group. These files are in known locations corresponding to the type of web server and/or framework. These files will not include files with PHP (or script processed by any local scripting engine like JavaScript (JS)).

In one embodiment, a whitelist may be generated locally by the agent (Block 211). The whitelist identifies a separate subset of the identified files that are permitted to be executed or accessed by the PHP engine. The administrator or similar user can identify files by adding them to the whitelist or the agent may automatically identify these files. Any combination of automatic or administered generation of the whitelist may be implemented. In some embodiments, the whitelist is provided partially or wholly by the security service. The security service can analyze the files local to the web server and send the agent a whitelist to install or a list of files to add to such a whitelist. In some embodiments, rather than a separate discrete list, the agent may alter file permissions to enable operation of the protection mechanism to effectively permit execution or access to specific files.

The protection mechanism in the PHP engine can then be sent to an active or ‘block’ mode where it will intercept calls by the web server or similarly intercede before the PHP engine processes files input by the web server (Block 213). The operation of the protection mechanism is described further herein below where the protection mechanism functions to block execution of unauthorized scripts where the protection mechanism determines that the web server user/group owns the file to be accessed by the PHP engine.

Protection Mechanism Overview

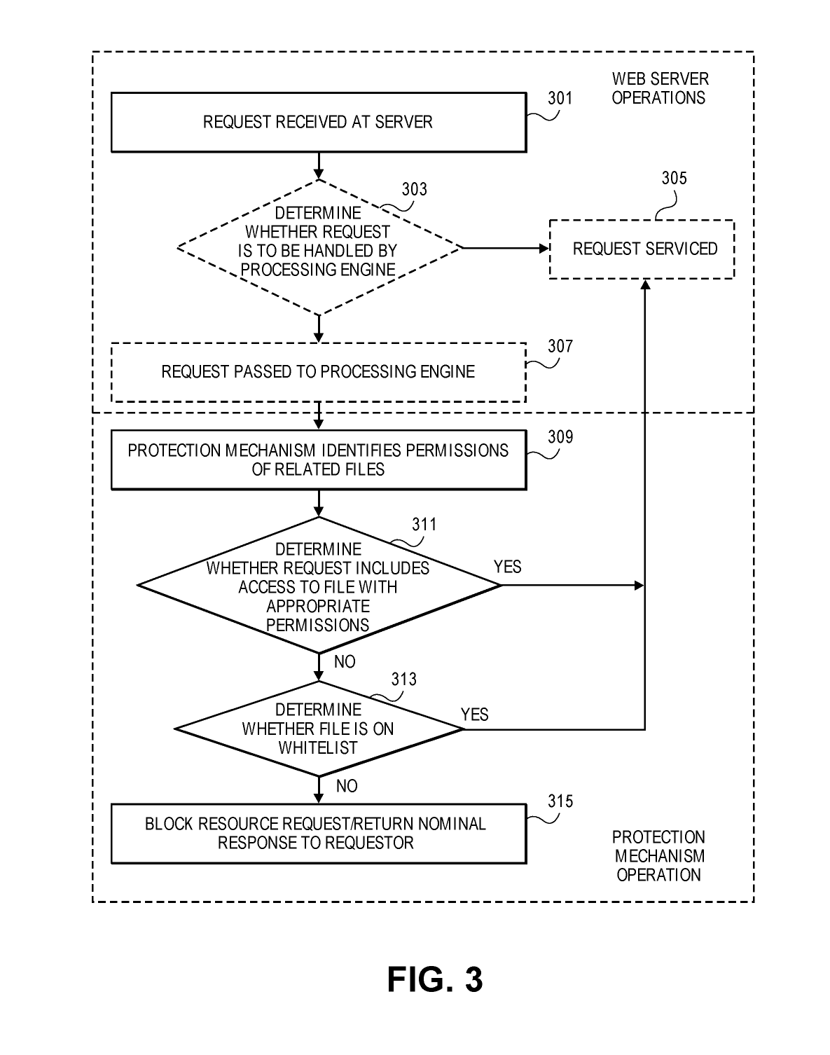

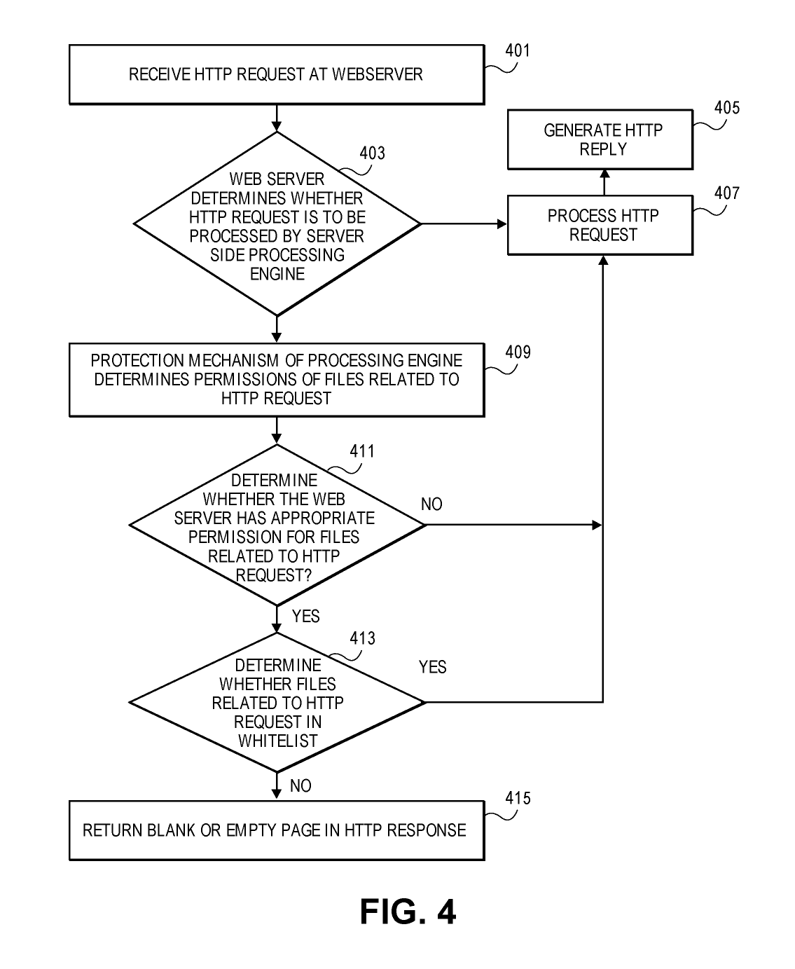

FIG. 3 is a flowchart of one embodiment of a process for handling requests at a server. The process is initiated in response to receiving a request at a server (Block 301). The server may be any type of software operating on a physical device or operating in a virtualized environment. The request can be any type of request for data, documents or similar query. The request can identify a requested document or data that a user seeks to obtain from the server. Example embodiments where the server is a web server are discussed with relation to FIG. 4 herein below. The server may include or operate in conjunction with a processing engine that functions to execute scripts or similar code to service a request. The server determines whether such a processing engine is needed to service the request or alternatively where the server can handle and service the request itself (Block 303). In the case where the processing engine does not need to be called to service the request, then the server or other components separate from the processing engine may handle the request including the generation of any reply for the request (Block 305).

If the request involves execution of code or script, then a corresponding processing engine may be called or invoked to service at least a portion of the request (Block 307). In some cases, a server may work in conjunction with any number of processing engines that execute various types of code or scripts. When the processing engine is called, then the protection mechanism may interrupt the call or similarly intercede to analyze the request and in particular the files affected by the request (Block 309). The protection mechanism checks the permissions related to any files referenced by the request. The protection mechanism then determines whether the request accesses files with the appropriate permissions as established by the agent during its operation where server related files are differently permissioned (e.g., by designating ownership by a specific user or group) (Block 311). If the files to be accessed are properly permissioned, then the protection mechanism allows the processing engine and the server to complete processing and servicing of the request (Block 305).

If the permissions of the files to be accessed are not properly permissioned, then the protection mechanism may check a whitelist to determine if the files with improper permissions are listed in the whitelist (Block 313). The protection mechanism may check each file that is to be accessed by a request and will look to block the servicing of any request where all of the files to be accessed are not properly permissioned or on the whitelist. If the file to be accessed is on the whitelist, the protection mechanism allows processing by the processing engine and server (Block 305). The whitelist may be a local whitelist specific to the server, processing engine and/or protection mechanism.

If the file permissions are not appropriate and the files to be accessed are not on a whitelist, then the protection mechanism blocks the servicing of the request by the processing engine and may generate a nominal or ambiguous response to be provided to a user that generated the request (Block 315). The protection mechanism may further log and report the blocked requests and identified files in the request to the security service for further analysis. In some embodiments, the protection mechanism may send copies or remove the identified files to the security service. The response can be a null value, a blank web page or similar response that leaves the user that generated the malicious request in the dark as to what has happened in the malicious effort to execute code or script at the server and thereby denying that malicious user additional information about the operation of the server to be utilized in further attacks on the server. The protection mechanism can record and report to the security service or directly to an administrator the blocked request as well as any identifying information such as IP address of the user that sent the request.

Example Web Server and Protection Mechanism Operation

FIG. 4 is a flowchart of another embodiment of a process for handling hyper-text transfer protocol requests at a web server. In this example, the process may be initiated by the web server receiving an HTTP request or HTTP secure (HTTPS) request (Block 401). While the embodiments herein discuss the servicing of HTTP requests, one skilled in the art would understand that this is equally applicable to HTTPS request processing. The web server determines whether the HTTP request requires processing by a processing engine (e.g., the HTTP request identifies a PHP script or similar code) where in this example the processing engine is a PHP engine (Block 403). If the HTTP request does not require a PHP engine to process the request, then the web server may be able to service the request (Block 409) and generate the appropriate HTTP reply (Block 405). If the HTTP request does require the PHP engine to process it, then the PHP engine may be called by the web server at which point the protection mechanism may interrupt the call or similarly intercede to analyze the HTTP request before the PHP engine processes the HTTP request.

The protection mechanism determines the permissions of the files being requested by the HTTP process, in particular those to be written to (Block 409). The protection mechanism determines the associated user or user group of the files to be accessed. The protection mechanism then determines whether the web server has write permission or generally the appropriate permissions for any of the files that are identified by the protection mechanism (Block 411). If the web server does not have write permission for these files, then the protection mechanism may allow the PHP engine to process them as the accesses to other files not belonging to the web server user or user group are not a threat to the web server and the HTTP request can be processed (Block 407) and a reply generated (Block 405) by the PHP engine and the web server.

However, if the permissions indicate that the owner of the files is the same user or group as that owns the web server, then the protection mechanism may check whether the HTTP request can nonetheless be processed by checking whether access to these files is permitted by a whitelist (Block 413). If the files to be accessed are on the whitelist then the protection mechanism may allow the PHP engine to process them as the accesses to other files not belonging to the web server user or user group are not a threat to the web server and the HTTP request can be processed (Block 407) and a reply generated (Block 405) by the PHP engine and the web server.

In the case where the files to be accessed by the HTTP request are owned by the same user or group as the webserver, and the files do not appear on a whitelist (or alternatively there is no whitelist mechanism), then the protection mechanism may block the servicing of the HTTP request by the PHP engine and instead return a blank or empty web page or similar content to the user that generated the HTTP request via a HTTP reply (Block 415). In this manner, the attempt to execute malicious code is blocked without providing a signal to the attacker that the web server has utilized a protection mechanism to block the malicious code. In addition, in some embodiments, the protection mechanism may report the source of the HTTP request (e.g., by source IP address), as well as information about the file that was to be accessed. The suspect files may be copied and sent to the security service and/or removed from the operating environment of the web server.

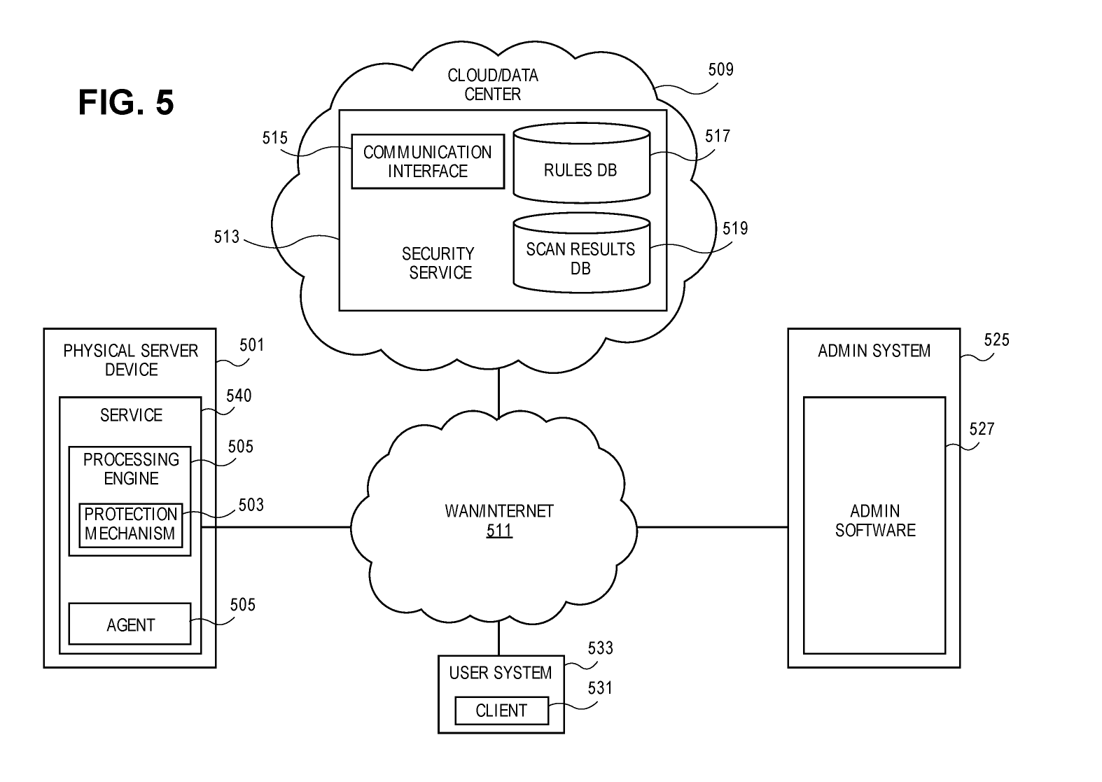

FIG. 5 is a diagram of one embodiment of a network architecture for the operation of a protection mechanism and security service. The network architecture is a simplified representation of an example architecture provided by way of example and not limitation. The protection mechanism 503 can be installed by an agent 505 or separately installed at server 540 or similar service. The service 540 can be executed by a physical computing device 501 by operating in an execution environment based on an operating system executing on the physical computing device 501 or in a virtualized environment with a hypervisor or similar execution environment provided by the physical computing device 501. In further embodiments, the execution environment may be distributed over multiple physical computing devices 501 with any component of the service 540, the processing engine 505, protection mechanism 503 or agent 505 implemented at any location (e.g., via systems like network function virtualization (NFV) or similar technologies.

The service or server 540 can by a web server or similar service. The web server can be any software capable of servicing HTTP requests or similar requests over a network environment. The service 540 may be accessible to users utilizing their own computing systems 533 and running various types of clients 531 such as web browsers or similar clients that communicate with the service v540 via HTTP or similar protocols. The service 540 can be connected with a wide area network (WAN) such as the Internet or similar network. The service 540 can be in communication with and managed by an administrator system 525 via administrative software or tools 527. The protection mechanism 503 may communicate with the administrative software 527 to provide notifications on blocked scripts or similar notifications about its operation. Similarly, the agent 505 may provide notifications regarding its operations.

Similarly, the protection mechanism 503 may be in communication with a security service 513. The security service 513 may enable communication via a communication API 515 and receive notifications from the protection mechanism 503 and agent 505. The security service 513 can collect scan results from agents in a scan results database or set of scan results databases 519 that can be analyzed to detect threats at the services 540 serviced by the security service 513. The security service 513 can manage any number of separate services 540 and associated protection mechanisms 503. The example illustrates a single service 540 and protection mechanism 503, however, one skilled in the art would appreciate that the security service 513 may communicate and interact with any number such services 540 and protection mechanisms 503. The security service 513 can be implemented via a cloud service or at a data center 509 to enable it to scale to manage any number of services 540 and protection mechanisms 503. The security service 513 can manage agents 505 including facilitating their installation and registration at each service. The security service 513 may provide a signature database or set of signature database (e.g., hashes, YARA signatures and similar identifier for malicious code or scripts) that is continuously updated and provided to agents 505 and similar components to assist in protecting services 540.

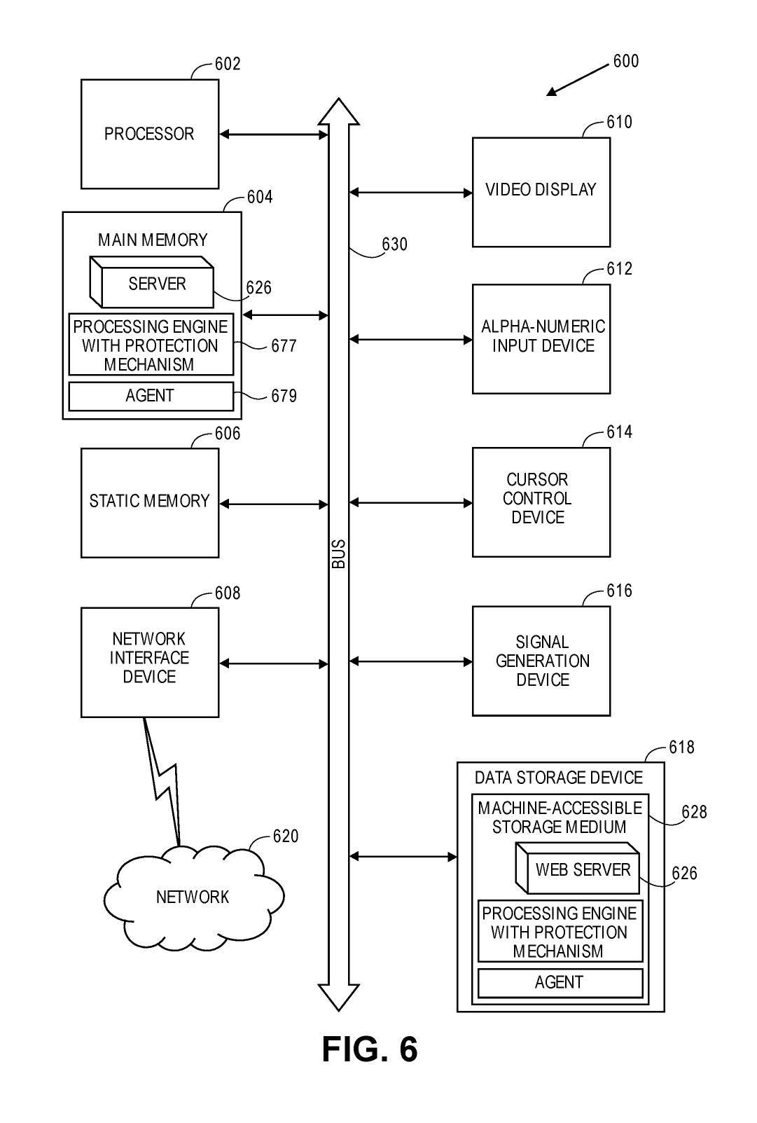

FIG. 6 is a diagram of one embodiment of a computing device implementing a protection mechanism. In various embodiments, the computing devices or machines implementing the protection mechanism and related components including the server, processing engine and agents may be connected (e.g., networked) to other machines in a Local Area Network (LAN), WAN, an intranet, an extranet, or the Internet. The computing device or machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies and components (e.g., the protection mechanism and its functions) discussed herein.

The exemplary computer system includes a processing device 602, a main memory 604 (e.g., read-only memory (ROM), flash memory, dynamic random-access memory (DRAM) such as synchronous DRAM (SDRAM) or Rambus DRAM (RDRAM), etc.), a static memory 606 (e.g., flash memory, static random-access memory (SRAM), etc.), and a secondary memory 618 (e.g., a data storage device), which communicate with each other via a bus.

The processing device 602 represents one or more general-purpose processing devices such as a microprocessor, central processing unit, or the like. More particularly, the processing device may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute a server 626, processing engine with protection mechanism 677 and/or agent 679 for performing the operations and steps discussed herein.

The computer system 600 may further include a network interface device 608. The computer system also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The secondary memory 68 may include a machine-readable storage medium 628 (or more specifically a non-transitory computer readable storage medium) on which is stored one or more sets of instructions (e.g., the server 626, processing agent 677 and/or agent 679) embodying any one or more of the methodologies or functions described herein (e.g., he server 626, processing agent 677 and/or agent 679). The he server 626, processing agent 677 and/or agent 679 (i.e., implementing the methods described in this document) may also reside, completely or at least partially, within the main memory 604 and/or within the processing device 602 during execution thereof by the computer system 600; the main memory 604 and the processing device also constituting machine-readable storage media. The he server 626, processing agent 677 and/or agent 679 may further be transmitted or received over a network via the network interface device 608.

The machine-readable storage medium 628, which may be a non-transitory computer readable storage medium, may also be used to store the parser generator 626 module persistently. While the non-transitory computer readable storage medium is shown in an exemplary embodiment to be a single medium, the term “non-transitory computer readable storage medium” should be taken to include a single medium or multiple media (e.g., a centralized or distributed database, and/or associated caches and servers) that store the one or more sets of instructions. The term “non-transitory computer readable storage medium” shall also be taken to include any medium that is capable of storing or encoding a set of instructions for execution by the machine that causes the machine to perform any one or more of the methodologies of the present invention. The term “non-transitory computer readable storage medium” shall accordingly be taken to include, but not be limited to, solid-state memories, and optical and magnetic media.

The computer system 600 may additionally include the he server 626, processing agent 677 and/or agent 679 for implementing the functionalities of the process described above. The module, components and other features described herein can be implemented as discrete hardware components or integrated in the functionality of hardware components such as ASICS, FPGAs, DSPs or similar devices. In addition, the module can be implemented as firmware or functional circuitry within hardware devices. Further, the module can be implemented in any combination of hardware devices and software components.

Some portions of the detailed descriptions which are presented herein are in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “executing,” “determining,” “setting,” “converting,” “constructing,” “traversing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

For example, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method for a protection mechanism associated with a server to prevent execution of malicious code, the method comprising:
identifying permissions of a set of files by the protection mechanism where the set of files are related to a request sent to the server;
determining whether the request references any file in the set of files with inappropriate permissions; and
blocking the request from being executed by a processing engine in response to determining the request is associated with at least one file with improper permissions.

2. The method of claim 1, wherein the blocking returns a response that results in an empty, blank or error result being presented to a requestor.

3. The method of claim 1, further comprising:
determining whether the at least one file with improper permissions is listed on a whitelist; and
allowing processing of the request in response to the at least one file with improper permissions being listed on the whitelist.

4. The method of claim 1, wherein inappropriate permissions include a file of the set of files have a common ownership with or are writeable by the server.

5. The method of claim 1, wherein the request is a hypertext transfer protocol (HTTP) or HTTP secure (HTTPS) request.

6. The method of claim 1, wherein the processing engine is a parser or scripting engine.

7. The method of claim 1, further comprising:
determining files associated with the server; and
changing the permissions on the files associated with the server to enable protection mechanism activation.

8. The method of claim 7, further comprising:
activating a protection mechanism to prevent execution of files introduced after protection mechanism activation.

9. The method of claim 1, further comprising:
generating a whitelist based on agent configuration, administrator input, security service information or an external source.

10. The method of claim 9, further comprising:
registering the agent with a cloud service; and
updating the agent with processes and instructions for scanning for the set of files from the cloud service.

11. An apparatus to execute a method for a protection mechanism associated with a server to prevent execution of malicious code, the apparatus comprising:
a non-transitory computer readable medium having stored therein a protection mechanism and a processing engine; and
a processor communicatively coupled to the non-transitory computer readable medium, the processor to execute the processing engine and the protection mechanism, the protection mechanism configured to identify permissions of a set of files by the protection mechanism where the set of files are related to a request sent to the server, to determine whether the request references any file in the set of files with inappropriate permissions, and to block the request from being executed by the processing engine in response to determining the request is associated with at least one file with improper permissions.

12. The apparatus of claim 11, wherein the blocking returns a response that results in an empty, blank or error result being presented to a requestor.

13. The apparatus of claim 11, wherein the protection mechanism is further to determine whether the at least one file with improper permissions is listed on a whitelist, and to allow processing of the request in response to the at least one file with improper permissions being listed on the whitelist.

14. The apparatus of claim 11, wherein inappropriate permissions include a file of the set of files have a common ownership with or are writeable by the server.

15. The apparatus of claim 11, wherein the request is a hypertext transfer protocol (HTTP) or HTTP secure (HTTPS) request.

16. The apparatus of claim 11, wherein the processing engine is a parser or scripting engine.

17. The apparatus of claim 11, wherein the device is further configured to execute an agent to determine files associated with the server, and to change the permissions on the files associated with the server to enable protection mechanism activation.

18. The apparatus of claim 17, wherein the agent is further configured to activate a protection mechanism to prevent execution of files introduced after protection mechanism activation.

19. The apparatus of claim 11, wherein the agent is further configured to generate a whitelist based on agent configuration, administrator input, security service information or an external source.

20. A non-transitory computer-readable medium, having stored therein a set of instructions, which when executed by a computing device cause the computing device to perform a set of operations to implement a protection mechanism associated with a server to prevent execution of malicious code, the set of operations comprising:
identifying permissions of a set of files by the protection mechanism where the set of files are related to a request sent to the server;
determining whether the request references any file in the set of files with inappropriate permissions; and
blocking the request from being executed by a processing engine in response to determining the request is associated with at least one file with improper permissions.
